(19) United States
(12) Patent Application Publication
(10) Pub. No.: US 2007/0086574 A1
(43) Pub. Date: Apr. 19, 2007

(54) X-ray tube

(76) Inventor: Eberhard Lenz, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/506,969

(22) Filed: Aug. 17, 2006

(30) Foreign Application Priority Data
Aug. 18, 2005 (DE) 10 2005 039 187.7

(51) Int. Cl. H01J 35/08

(52) U.S. Cl. 378/143

(57) ABSTRACT

An x-ray tube has a cathode and an anode produced from a first material. In order to prevent unwanted accretions from forming due to the evaporation of the anode material, a layer produced from a second material is provided on the anode at the side thereof facing the cathode. The layer exhibits a lower vapor pressure than the first material at a temperature of 800° C.

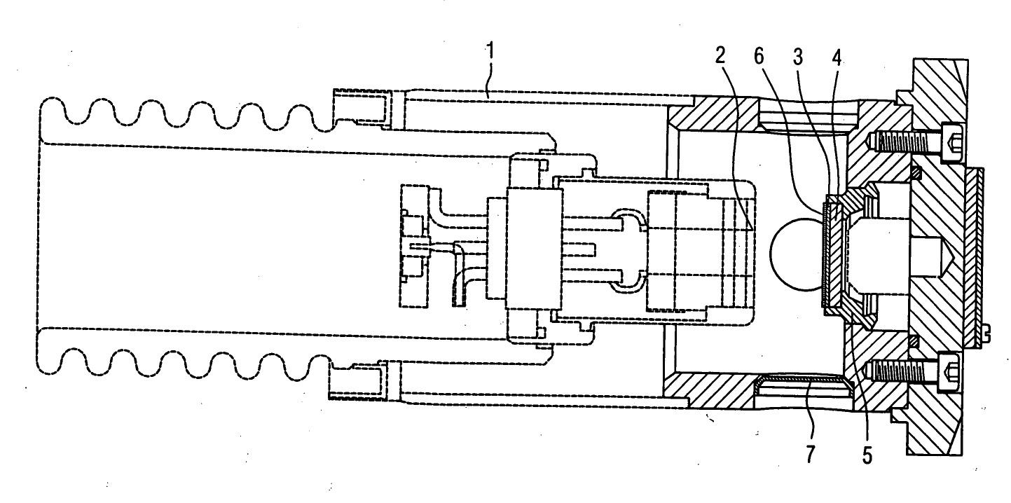

### BACKGROUND OF THE INVENTION

1. Field of the Invention

The present invention concerns an x-ray tube of the type having an anode composed of a metal.

2. Description of the Prior Art

X-ray tubes of the above type are generally known. In the generation of x-ray radiation, due to deceleration of electrons from the cathode that strike the anode, the material (namely a metal) forming the anode heats significantly. The metal forming the anode exhibits an atomic number of at least 22. In spite of the preferred usage of metals with a high melting point, evaporation of the metal occurs in the operation of the x-ray tube. The metal vapor precipitates on colder regions of the x-ray tube, in particular on the x-ray exit window. Such deposits formed by evaporated metal are particularly unwanted in the region of the x-ray exit window because they absorb x-rays and thus limit the performance of the x-ray tube.

DE 2 154 888 A1, DE 103 01 069 A1, DE 196 50 061 A1, U.S. Pat. No. 5,943,389, PCT Application WO 03/043046 as well as U.S. Pat. No. 4,271,372 describe anodes in which the metallic anode material is joined on its side facing away from the cathode with a material with high heat storage capacity. This material is either graphite, graphite fiber composite materials, porous materials with pores filled with a heat-conductive material, or the like.

### SUMMARY OF THE INVENTION

An object of the invention is to provide an x-ray tube that reliably delivers a high and constant performance.

This object is achieved according to the invention by an x-ray tube having an anode composed of metal, as a first material, on its first side facing the cathode, is provided at least in a focal zone struck by electrons with a layer formed from a second material to reduce evaporation of the first material. The second material exhibits a property different from the first material that reduces evaporation of the first material. Unwanted accretions formed by vaporized solid material are thus reduced in the region of the x-ray exit window and a high and constant performance of the x-ray tube can be achieved.

In an embodiment, on the first side facing the cathode, the anode is covered over its entire surface with the layer formed of the second material. This means that that layer formed from the second material also covers the anode outside of the focal zone. This simplifies the production of the layer and contributes to a particularly effective minimization of the evaporation of the first material.

According to a further embodiment, the second material exhibits a lower vapor pressure than the first material at a temperature of 800° C. Unwanted evaporation of the first material thus is minimized during operation of the anode at high temperatures. As a result, no accretions formed from the first material can precipitate on the x-ray exit window, such accretions disadvantageously absorbing x-ray radiation. The x-ray tube thus can be durably operated at high anode temperatures essentially without performance loss.

As used herein, “focal zone” means a portion of the anode that is struck by the electron beam emitted from the cathode in operation. In the case of a rotating anode or a rotating envelope tube, the focal zone forms an annular zone (ring) on the anode.

The second material is preferably selected from the following group: SiO₂, TiO₂, CrN, TaC, HfC, WC, WB, Re, TaB, HfB, TiAIN, TiAICN, Ta, TiB, B, Co, Ni, Ti, V, Pt. The cited compounds are characterized by a very low formation enthalpy and therewith (according to general practical experience) by a particularly low vapor pressure.

In an advantageous embodiment, SiO₂ can be used and provided with filling material produced from carbon or TiO₂. This embodiment is characterized by an improved stability and electrical conductivity of the second material, in particular at high temperatures. The layer can exhibit a thickness in the range of 0.2 to 1.0 μm. A thickness of the layer in the range from 0.3 to 0.8 μm has proven to be particularly advantageous.

According to a further embodiment, for dissipation of heat on its side facing away from the cathode, the anode is provided at least in sections with a heat conductor element produced from a third material exhibiting a higher heat conductivity than the first material, the third material exhibiting a heat conductivity of at least 500 W/mK.

A significantly improved dissipation of the heat from the anode thus can be realized. The performance of the x-ray tube can be improved by up to 15%.

In a further embodiment, the third material is produced from graphite doped with titanium. At room temperature such a material exhibits a heat conductivity of at least 690 W/mK in at least two crystallographic planes. The heat conductivity of such doped graphite is notably higher than the heat conductivity of conventional graphite or of copper. It has proven to be advantageous to orient the doped graphite in the heat conductor element such that at least one crystallographic plane exhibiting the aforementioned high heat conductivity is oriented essentially perpendicularly to the first side of the anode.

In a further embodiment, the third material is a composite material formed of graphite and copper with a heat conductivity of more than 800 W/mK. The composite material can also embody tube-like structures produced from graphite with a diameter of 10 to 100 nm (known as nanotubes) which are embedded in the copper. An excellent heat dissipation from the anode can be realized with this composite material.

According to a further embodiment of the invention, the heat conductor element is accommodated in a carrier structure produced from copper. The carrier structure can be a component of the anode produced from the first material. Alternatively, it can be a separate component that accommodates the heat conductor element and is mounted on the first side of the anode.

The first material can be selected from the following group: Cu, Rh, Mo, Fe, Ni, Co, Cr, Ti, W or an alloy which predominantly contains one of the aforementioned metals. Such a first material exhibits a particularly high melting point and enables operation of the anode at high temperatures.

It is also possible to use W as the second material in the event that the first material is different from W.

The anode can be a fixed anode or a rotating anode that can be rotated relative to the cathode. The anode can be a component of a rotating envelope tube. Particularly high efficiencies can be achieved given the use of the inventive anode as a component of a rotating anode or of a rotating envelope tube.

### DESCRIPTION OF THE DRAWINGS

The single figure is a side view, partly in section, of an embodiment of an x-ray tube constructed in accordance with the principles of the present invention.

### DESCRIPTION OF THE PREFERRED EMBODIMENTS

A sectional view of an x-ray tube with fixed anode is schematically shown in the single drawing. An anode 3 (for example produced from tungsten) is provided opposite a cathode 2 in a vacuum-sealed housing 1. On the anode 3, a heat conductor (dissipater) element 4 is attached on the side facing away from the cathode 2. The heat conductor element 4 is formed of a material which exhibits a higher heat conductivity in comparison to the anode material. The heat conductor element 4, for example, can be produced from graphite doped with titanium, having a heat conductivity of >650 W/mK. Insofar as the heat conductor element 4 is anisotropic with regard to its heat conductivity, it is attached on the anode 3 such that the direction of the maximum heat conductivity proceeds approximately perpendicularly to the surface of the anode 3.

On its side facing the cathode 2, the anode 3 is provided with a layer 6 produced, for example, from TaC or HfC. The material used for production of the layer 6 exhibits a lower vapor pressure at 800° than the material used for production of the anode 3. As a consequence, evaporation of the anode material and the unwanted precipitation thereof on an x-ray exit window 7 are prevented.

The layer 6 preferably exhibits a thickness of 300 to 700 nm. For example, it can be applied on the anode 3 by a Sol-Gel method or a PVD method.

Fibers produced from graphite are also suitable for forming the heat conductor element 4, suitable fibers of this type are offered by the company Cytec Engineered Materials GmbH under the trademark “THORNEL CARBON FIBRES”. Graphite fibers offered by the same company under the trademark “THERMALGRAF” are likewise suitable. Plates can be produced from the aforementioned fibers, which plates in turn form the starting material for production of the heat conductor element 4.

Although modifications and changes may be suggested by those skilled in the art, it is the intention of the inventor to embody within the patent warranted hereon all changes and modifications as reasonably and properly come within the scope of his contribution to the art.

I claim as my invention:

1. An x-ray tube comprising:
a cathode that emits an electron beam upon being struck by said electron;
an anode that emits x-rays;
said anode being comprised of metal, said anode having a side facing said cathode with a focal zone thereon in a path of said electron beam that is struck by electrons in said electron beam; and
said anode, at least in said focal zone, comprising a layer comprised of a material that minimizes evaporation of said metal due to said electrons striking said anode.

2. An x-ray tube as claimed in claim 1 wherein said layer completely covers said anode at said side facing said cathode.

3. An x-ray tube as claimed in claim 1 wherein said material has a lower vapor pressure than said metal at a temperature of 800° C.

4. An x-ray tube as claimed in claim 1 wherein said material is a material selected from the group consisting of SiO₂, TiO₂, CrN, TaC, HfC, WC, WB, W, Re, TiB, HfB, TiAIN, TiAICN, B, Co, Ni, Ti, V, Pt, Ta.

5. An x-ray tube as claimed in claim 1 wherein said material comprises SiO₂ embodying a filling material selected from the group consisting of C and T TiO₂.

6. An x-ray tube as claimed in claim 1 wherein said layer has a thickness in a range between 0.2 μm and 1.0 μm.

7. An x-ray tube as claimed in claim 1 wherein said anode has a side facing away from said cathode, said side facing away from said cathode, at least in sections thereof, comprising a heat conductor element formed of a further material exhibiting a higher heat conductivity than said material forming said layer, said third material exhibiting a heat conductivity of at least 500 W/mK.

8. An x-ray tube as claimed in claim 7 wherein said third material is graphite doped with titanium.

9. An x-ray tube as claimed in claim 7 wherein said third material is a composite material comprised of graphite and copper, having a heat conductivity of more than 800 W/mK.

10. An x-ray tube as claimed in claim 9 wherein said composite material comprises graphite tubular structures embedded in copper, said tubular structures having a diameter in a range between 10 nm and 100 nm.

11. An x-ray tube as claimed in claim 7 comprising a copper carrier structure at said side of said anode facing away from said cathode, in which said further material is contained.

12. An x-ray tube as claimed in claim 1 wherein said metal is a metal from the group consisting of Cu, Rh, Mo, Fe, Ni, Co, Cr, Ti, and alloys predominantly containing one of Cu, Rh, Mo, Fe, Ni, Co, Cr, Ti.

13. An x-ray tube as claimed in claim 1 wherein said metal is a metal other than W, and wherein said material is W.

14. An x-ray tube as claimed in claim 1 comprising a tube housing, and wherein said anode is a fixed anode at a fixed location in said tube housing relative to said cathode.

15. An x-ray tube as claimed in claim 1 comprising a tube housing, and wherein said anode is a rotating anode mounted for rotation in said tube housing relative to said cathode.

16. An x-ray tube as claimed in claim 1 comprising a rotatable tube housing forming a rotating envelope tube, and wherein said anode is a component of said rotatable tube housing.
